(19) United States
(12) Patent Application Publication
(10) Pub. No.: US 2009/0056210 A1
(43) Pub. Date: Mar. 5, 2009

(54) FLOWER TRANSPORTING DEVICE

(76) Inventor: CHRISTIE R. FORTNER, Florence, KY (US)

Correspondence Address: CHRISTIE R. FORTNER, 1410 TARAMORE DRIVE, FLORENCE, KY, 41042, US

(21) Appl. No.: 11/782,622

(22) Filed: Jul. 24, 2007

(51) Int. Cl. A01G 5/04; A47G 7/00

(52) U.S. Cl. 47/41.01

(57) ABSTRACT

A flower transporting container and method for transporting one or more flowers is provided. The flower transporting container includes a flower receptacle that defines at least one opening, and optionally, a plurality of such openings. Each opening is configured to receive one or more flowers, such as arranged in a bouquet or other flower arrangement. A recess formed in the flower receptacle receives a cooling medium, which cools the plants, flowers, or bouquets of the same during transportation. The flower transporting container protects and cools such plants, flowers, or bouquets of the same to reduce the risk of disarrangement and damage during transportation.

### BACKGROUND

Florists generally transport fresh cut flowers in bouquets or other arrangements to weddings, funerals, or other events. During transportation, the floral bouquets are susceptible to damage and disarrangement. Additionally, the floral bouquets can become overheated or wilted during transportation. Wilted flowers are generally less appealing and desirable than fresh, non-wilted flowers. Devices to transport such floral bouquets are known.

Sometimes florists wrap the floral bouquets in paper without any moisture dispenser, or frequently pack the floral bouquets with the stems wrapped in water-saturated cotton or a small sponge. Such configurations do not protect the floral bouquets from weather and other natural elements, such as rain or snow. Another known type of transport for maintaining freshness is a small container partially filled with water. Such water-filled containers generally cannot be hermetically sealed and thus tend to leak.

While such devices provide a particular function, none addresses a broad capability to protect and cool one or more flowers, plants, or floral bouquets of the same during transportation. There is thus a need to provide new and different flower, plant, or floral bouquet transporting devices as well as new and different ways to protect, hydrate, and cool such flowers, plants, and floral bouquets during transportation.

### SUMMARY

In one embodiment, a flower, plant, or floral bouquet transporting container supports at least one flower, plant or floral bouquet. The transporting container can support a single plant or flower, a bouquet of plants or flowers, or any other suitable arrangement of plants, flowers, or botanical items. The container includes a floral bouquet receptacle configured to removably receive floral bouquets therein. The floral bouquet receptacle defines at least one opening, and optionally, a plurality of such openings. The configuration of each opening positions and supports one or more floral bouquet inserted therein. In one embodiment, one or more of the floral bouquets are inserted into a vase or other water-carrying holder, which is inserted into one or more of the openings.

In one embodiment, the floral bouquet receptacle also defines at least one recess, which is configured to removably receive a cooling medium. In one embodiment, the cooling medium is a gas, liquid, solid, or gel contained in a container. In this instance, the at least one recess is sized and shaped to removably receive the cooling medium container.

In one embodiment, a plurality of deflection members defines each opening in the flower receptacle. The deflection members substantially surround a circumference of each opening. Each deflection member deflects when one or more floral bouquets are inserted into the opening. The deflection members engage the floral bouquets or a part thereof (e.g., a stem), which supports the flowers in the openings and helps protect such flowers during the storage and transport thereof. In one embodiment, the deflection members engage a vase or other device capable of holding floral bouquets and providing a water source.

In one embodiment, a housing removably receives the flower receptacle. The flower receptacle can be removed from the housing, which enables access to any of the plants or flowers supported by the flower receptacle. In one such embodiment, the flower receptacle is inserted into the housing so that the housing provides stability and support to the flower receptacle.

Additional features, objects, and aspects of the disclosed embodiments are described in, and will be apparent from, the following Detailed Description and the Figures.

### BRIEF DESCRIPTION OF THE FIGURES

FIG. 1 is a perspective view of a container that includes a housing and a flower receptacle in accordance with one disclosed embodiment.

FIG. 2 is a perspective view of a container that includes a housing and a flower receptacle in accordance with one disclosed embodiment.

FIG. 3 is a plan view of the housing of the container shown in FIG. 1.

FIG. 4 is a perspective view of the housing shown in FIG. 2.

FIG. 5 is a plan view of the flower receptacle of the container shown in FIG. 1 in accordance with one disclosed embodiment.

FIG. 6 is a perspective view of the flower receptacle shown in FIG. 5.

FIG. 7 is a side view of the flower receptacle in accordance with one disclosed embodiment.

FIG. 8 is a partial front view of the flower receptacle in accordance with one disclosed embodiment.

### DETAILED DESCRIPTION

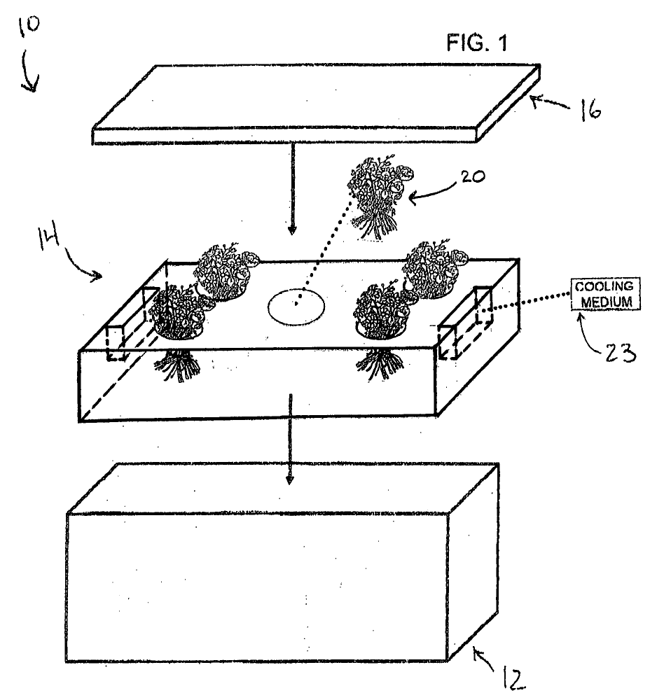

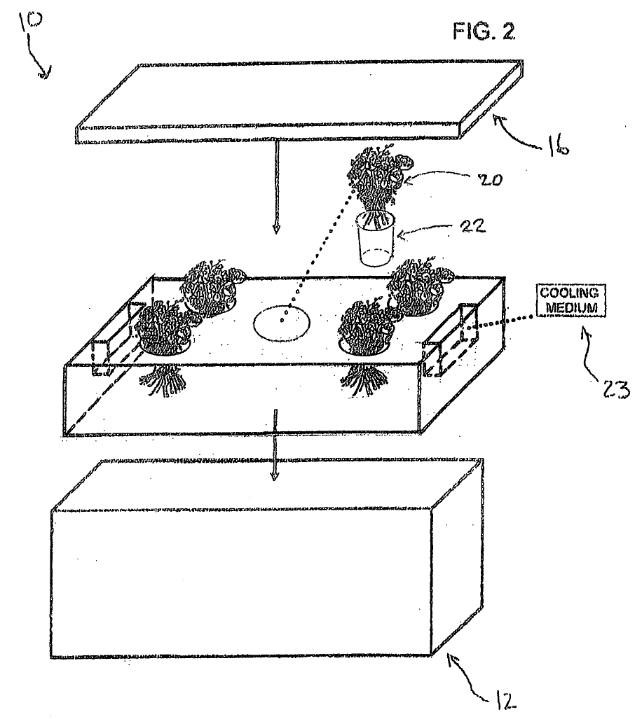

Referring now to FIGS. 1 and 2, one embodiment of the flower transporting device or container 10 includes a housing 12 and a flower receptacle 14. The housing 12 defines an open area that receives the flower receptacle 14. A lid or other covering member 16 closes the open area defined by the housing 12. The flower receptacle 14 defines at least one opening 18, and optionally, a plurality of such openings 18 therein.

Each opening 18 positions and supports at least one flower, plant, or botanical item 20, such as a single rose, a bouquet of roses, or any other suitable flower or plant. The one or more flowers, plants, and bouquets of the same are referred to herein as a flower arrangement or a floral bouquet 20. The flower arrangement may include one or more of the same type or different types of flowers or plants. Such flower arrangements or floral bouquets are usually displayed in weddings, funerals, or retail outlets. As illustrated in the embodiment shown in FIG. 1, the opening 18 directly receives the floral bouquet 20 inserted therethrough. As illustrated in the embodiment shown in FIG. 2, the opening 18 directly receives a vase or other device for holding floral bouquets 21. In this embodiment, the floral bouquet 20 is inserted into the vase 21. In one embodiment, the vase 21 is at least partially filled with water to hydrate the floral bouquets during transport.

The flower receptacle 14 also defines at least one recess 22, and optionally, a plurality of such recesses 22 therein. The recess 22 is configured to removably receive a cooling medium 23. It should be appreciated that the cooling medium may include a liquid, a gas, a solid, or a gel. Examples of the cooling medium include, but are not limited to, water, ice, nitrogen, glycol, or any other suitable liquid, gas, solid, or gel capable of cooling plants or flowers. In one embodiment, the cooling medium 23 is contained in a container or holder, which is sized and shaped to be removably received within the at least one recess 22. In one embodiment, the cooling medium 23 is an ice pack or dry ice. In this instance, the ice pack or dry ice is sized and shaped to be removably received within the at least one recess 22.

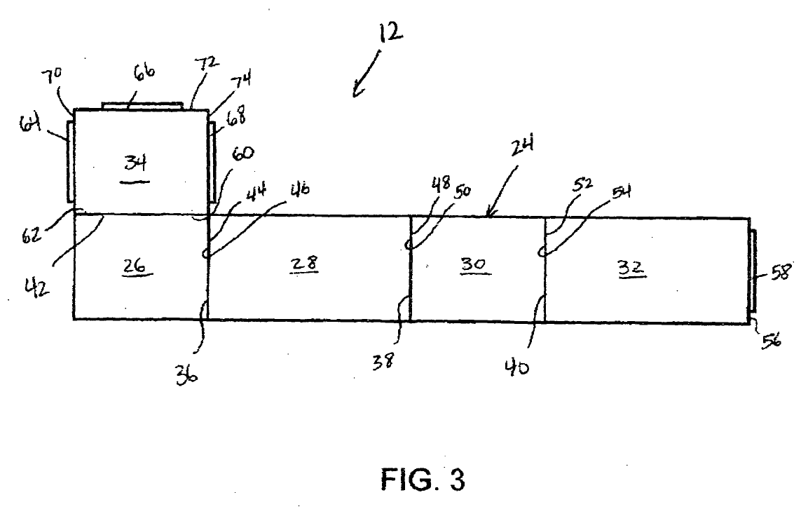

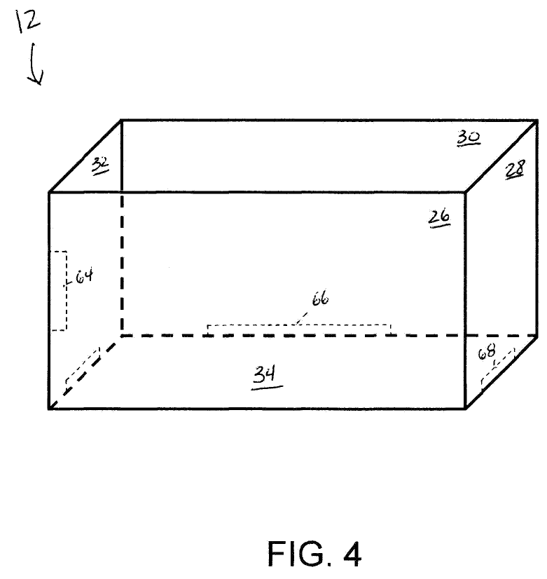

Referring now to FIGS. 3 and 4, one embodiment of the housing 12 includes a blank 24 of cardboard, plastic, foam, composite, or any other suitable material. The blank 24 includes a plurality of side wall portions 26, 28, 30, and 32 and a bottom portion 34 connected together along a plurality of foldable lines 36, 38, 40, and 42. The foldable lines 36, 38, 40, and 42 enable the wall portions 26, 28, 30, and 32 and the bottom portion 34 of the blank 24 to fold into, or otherwise form, the housing 12. As illustrated in FIG. 4, the housing 12 folds into a box-like configuration.

With reference to FIG. 3, a first edge 44 of the wall portion 26 is adjacent to and connected with a first edge 46 of the wall portion 28 along a first fold line 36. A second edge 48 of the wall portion 28 is adjacent to and connected with a first edge 50 of the wall portion 30 along a second fold line 38. A second edge 52 of the wall portion 30 is adjacent to and connected with a first edge 54 of the wall portion 32 along a third fold line 40. A flange 58 extends outwardly from a second edge 56 of the wall portion 32.

A first edge 60 of the bottom portion 34 is adjacent to and connected with a second edge 62 of the wall portion 26 along a fourth fold line 42. A flange 64, 66, and 68 extends outwardly from second, third and fourth edges 70, 72, and 74 of the bottom wall portion 34, respectively.

FIG. 4 illustrates the housing 12 formed into the box-like configuration. To form the housing 12 in this manner, the side wall portion 26 of the blank 24 folds about the first fold line 36, the side wall portion 28 of the blank 24 folds about the second fold line 38, and the side wall portion 30 of the blank 24 folds about the third fold line 40. Flange 58 abuts against and is fixedly secured, such as through adhesive or bonding material, to an inner surface of the side wall portion 26. The bottom portion 34 of the blank 24 folds about the fourth fold line 42 so that tabs 64, 66, and 68 abut against inner surfaces of side wall portions 32, 30, and 28, respectively. Tabs 64, 66, and 68 are fixedly secured, such as through adhesive or bonding material, to an inner surface of the side wall portions 32, 30 and 28. Once tabs 64, 66, and 68 are fixedly secured to the respective inner surfaces of the side wall portions 26, 28, 30, and 32, the blank 24 is formed into the housing 12.

Once the housing 12 is assembled, the side wall portions 26, 28, 30, and 32 define an open area therebetween. The lid or covering member 16 is configured to cover this opening when the lid 16 is positioned onto the housing 12. Alternatively, in one embodiment, the container 10 does not include the lid 16. In one such embodiment, upper edges of the side wall portions 26, 28, 30, and 32 are foldable toward the open area. With the upper edges folded toward the open area, the upper edges define a support surface of sufficient strength to support another container 10 thereon. It should be appreciated that the container 12 can be formed into any suitable size and shape. The box-like configuration illustrated in FIGS. 3 and 4 is one example of such container 12.

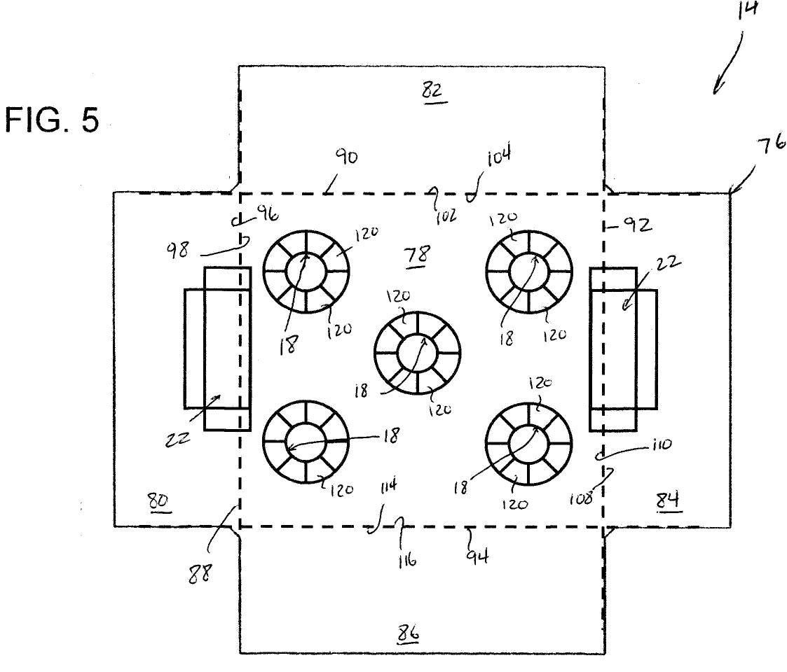

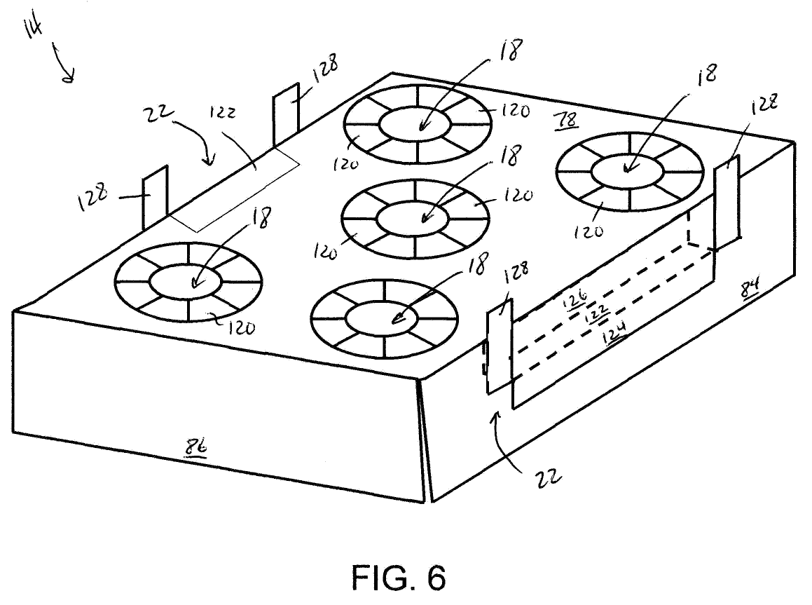

Referring now to FIGS. 5 and 6, one embodiment of the flower receptacle 14 includes a blank 76 of cardboard, plastic, foam, composite, or any other suitable material. The blank 76 includes a support surface 78 centrally positioned between a plurality of side wall portions 80, 82, 84, and 86. The support surface 78 and the side wall portions 80, 82, 84, and 86 connect together along a plurality of foldable lines 88, 90, 92, and 94, respectively. The foldable lines 88, 90, 92, and 94 enable the wall portions 80, 82, 84, and 86 of the blank 76 to fold into, or otherwise form, the flower receptacle 14.

With reference to FIG. 4, a first edge 96 of the flower support surface 78 is adjacent to and connected with a first edge 98 of the wall portion 80 along the fold line 88. A second edge 102 of the flower support surface 78 is adjacent to and connected with a first edge 104 of the wall portion 82 along the fold line 90. A third edge 108 of the flower support surface 78 is adjacent to and connected with a first edge 110 of the wall portion 84 along the fold line 92. A fourth edge 114 of the flower support surface 78 is adjacent to and connected with a first edge 116 of the wall portion 86 along the fold line 94.

As illustrated in FIGS. 5 and 6, the flower support surface 78 includes a plurality of openings 18. A plurality of deflection elements 120 defines each opening 18. The deflection elements 120 substantially surround a circumference of each opening 18. Each deflection member 120 deflects to support the one or more flowers when inserted into one of the openings 18.

The number of the openings 18 in the support surface 78 can vary as desired by the manufacturer of the flower receptacle 14. For example, the support surface can include one opening 18 or a plurality of openings 18. Similarly, the size and shape of the openings 18 can vary as desired by the manufacturer of the container 10 and/or the flower receptacle 14. For example, one of the openings 18 may be larger (e.g., have a larger diameter) than at least one other of the openings 18. In another example, one of the openings 18 may be a different shape than another one of the openings 18 (e.g., one opening may be circular while another may be oval-shaped). It should be appreciated that the support structure 78 of the flower receptacle 14 can define any suitable number of openings 18 of the same or different sizes and of the same or different shapes.

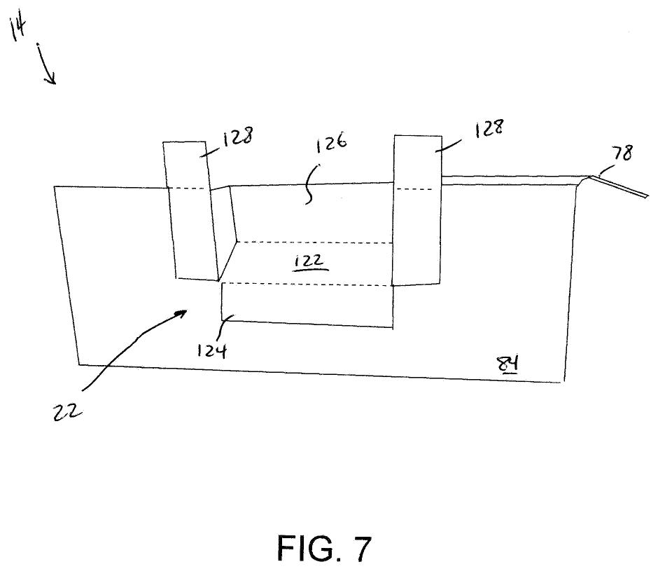

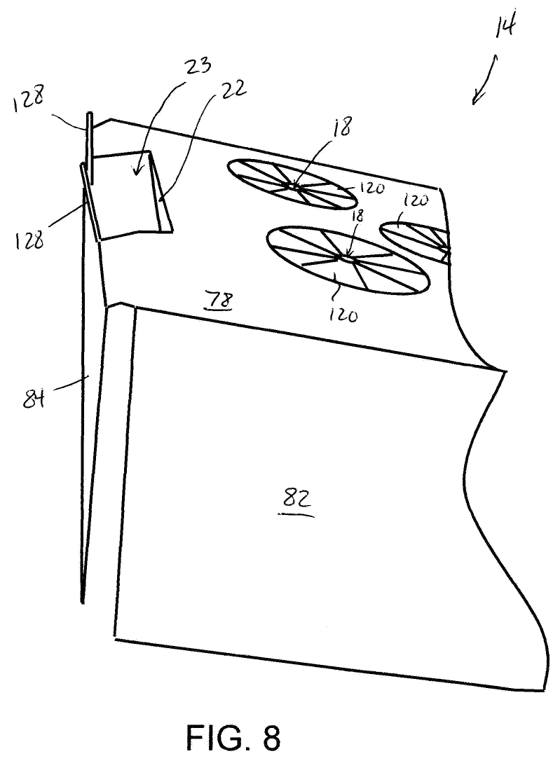

In one embodiment, at least one of the side wall portions 80, 82, 84, and 86 of the blank 76 define the recess 22 therein. As illustrated in FIGS. 5 to 8, the wall portions 80 and 84 each define one recess 22 therein. In another embodiment, one of or all of the wall portions 80, 82, 84, and 86 of the blank 76 define the recess 22 therein.

As shown in FIGS. 5 to 8, and described above, at least one recess 22 is formed in the wall portion 80 to removably receive a cooling medium capable of cooling plants or flowers, such as the cooling medium 23 described above. Each recess 22 includes a floor or bottom wall 122 connected between a front wall 124 and a rear wall 126. The floor 122 separates the front wall 124 from the rear wall 126. The floor 122 and the rear wall 126 provide a substantially L-shaped support for the cooling medium 23. A pair of longitudinal extensions 128 extend adjacent to the floor 122 and the rear wall 126. In one embodiment, the longitudinal extensions 128 extend upwardly (i.e., vertically) in the substantially same plane as the front wall 124.

In one embodiment, the cooling medium 23 is contained in a sealed or substantially sealed container. One example of such a cooling medium 23 is an ice pack. In one such embodiment, the floor 122, the front wall 124, the rear wall 126, and the extensions 128 of each recess 22 are sized and shaped to removably receive the container of the cooling medium 23. In another embodiment, the recess 22 is sized and shaped to removably receive at least one ice pack. Alternatively, the cooling medium is positioned directly into the recess 22 without being contained by a container. It should be appreciated that the cooling medium may include water, ice, nitrogen, glycol, or any other suitable liquid, gas or gel.

In the embodiments illustrated in FIGS. 1 and 2, the flower receptacle 14 is configured to be positioned into the open area defined by the side wall portions 26, 28, 30, and 32 of the housing 12. In such position, the housing 12 and the flower receptacle 14 are sized and shaped so that the side wall portions 26, 28, 30, and 32 of the housing 12 substantially abut against the side wall portions 80, 82, 84, and 86 of the flower receptacle 14. This substantial abutment helps reduce movement of any flower arrangements supported by the flower receptacle 14 during transport, and maintain any containers of cooling medium positioned in the recesses 22.

The side wall portions 26, 28, 30, and 32 extend upwardly and have a greater height than the side wall portions 80, 82, 84, and 86 of the flower receptacle 14. This greater height affords protection to any flower arrangements supported by the flower support structure.

In an alternative embodiment, the housing 12 and the flower receptacle 14 form a single, integral flower transporting container. In one such embodiment, the first, second, third and fourth edges of the flower support surface of the support structure 14 are integral with the inner surfaces of the wall portions of the housing to form a single, integral container. In one embodiment, the container 10 includes a stand-alone flower receptacle 14, which may be formed from a non-foldable and partially rigid construction.

It should be understood that various changes and modifications to the presently preferred embodiments described herein will be apparent to those skilled in the art. Such changes and modifications can be made without departing from the spirit and scope of the present invention and without diminishing its intended aspects. It is therefore intended that such changes and modifications be covered by the appended claims.

The invention is claimed as follows:

1. A container comprising:
a flower receptacle having a top wall and a plurality of side walls, the top wall defining at least one opening configured to receive at least one flower therethrough, and at least one of the side walls defining at least one recess; and
a cooling medium in communication with the at least one recess, the cooling medium being operable to cool the one or more flowers received in the at least one opening.

2. The container of claim 1, wherein the at least one flower is arranged in a floral bouquet comprising a plurality of flowers.

3. The container of claim 1, wherein the cooling medium is contained in a cooling medium container.

4. The container of claim 3, wherein the at least one recess is configured to removably receive the cooling medium container.

5. The container of claim 4, wherein at least one of the side walls includes a pair of extension members, each extension member configured to cooperate with the at least one recess to support the cooling medium container.

6. The container of claim 1, wherein the top wall includes a plurality of deflection members substantially surrounding the at least one opening.

7. The container of claim 1, which includes a housing configured to removably receive the flower receptacle.

8. A method for transporting plants, the method comprising:
providing a flower receptacle having a top wall and a plurality of side walls, the top wall defining at least one opening configured to receive at least one flower therethrough, and at least one of the side walls defining at least one recess; and
enabling a cooling medium to be placed in communication with the at least one recess, the cooling medium being operable to cool the at least one flower when received in the at least one opening defined in the flower receptacle.

9. The method of claim 8, which includes receiving the at least one flower in the at least one opening, the at least one flower arranged in a floral bouquet comprising a plurality of flowers.

10. The method of claim 8, which includes supporting the cooling medium contained in a cooling medium container.

11. The method of claim 10, which includes removably receiving the cooling medium container.

12. The method of claim 8, which includes substantially surrounding the at least one opening with a plurality of deflection members configured to deflect when the at least one flower is inserted into the at least one opening.

13. A floral bouquet holder comprising:
a top wall defining at least one opening configured to receive at least one floral bouquet therethrough, and
a plurality of side walls connected to the top wall, at least one of the side walls defining a recess therein, the recess configured to receive a cooling medium.

14. The floral bouquet holder of claim 13, wherein the cooling medium is operable to cool the floral bouquet received in the at least one opening.

15. The floral bouquet holder of claim 13, wherein the at least one floral bouquet includes a plurality of flowers removably received in a vase.

16. The floral bouquet holder of claim 13, wherein the cooling medium is contained in a cooling medium container.

17. The floral bouquet holder of claim 16, wherein the at least one recess is configured to removably receive the cooling medium container.

18. The floral bouquet holder of claim 17, wherein at least one of the side walls includes at least one extension member, each extension member configured to cooperate with the at least one recess to support the cooling medium container.

19. The floral bouquet holder of claim 13, wherein the top wall includes a plurality of deflection members substantially surrounding the at least one opening.

20. The floral bouquet holder of claim 13, wherein the cooling medium is an ice pack.
